(19) United States
(12) Patent Application Publication
(10) Pub. No.: US 2010/0015461 A1
(43) Pub. Date: Jan. 21, 2010

(54) Method and Apparatus for Anticorrosive Coating

(75) Inventors: N. TIM LARSEN, NEW PORT RICHEY, FL (US); Dale Wolf, Meridian, ID (US)

Correspondence Address: WINSTEAD PC, P.O. BOX 50784, DALLAS, TX, 75201, US

(73) Assignee: GERDAU AMERISTEEL US, INC., Tampa, FL (US)

(21) Appl. No.: 12/203,121

(22) Filed: Sep. 2, 2008

Related U.S. Application Data
(62) Division of application No. 11/165,852, filed on Jun. 23, 2005, now abandoned.
Application No. 11/165,852 is a continuation-in-part of application No. 10/326,610, filed on Dec. 20, 2002.
(60) Provisional application No. 60/343,462, filed on Dec. 20, 2001.

(51) Int. Cl. B32B 15/02

(52) U.S. Cl. 428/551; 428/553

(57) ABSTRACT

An embodiment of an anticorrosive metal workpiece includes an anticorrosive metallic coating principally composed of sprayed zinc particles adhered to a metal surface of the workpiece and a protective coating covering the metallic coating.

### RELATED APPLICATIONS

This application if a division of U.S. patent application Ser. No. 11/165,852, currently pending, filed on Jun. 23, 2005, which is a continuation-in-part of U.S. patent application Ser. No. 10/326,610, now abandoned, filed Dec. 20, 2002, which claims the benefit of U.S. Provisional Patent Application Ser. No. 60/343,462, filed Dec. 20, 2001.

### BACKGROUND

The present invention relates generally to the application of anticorrosive coatings, and more particularly, to application of anticorrosive coatings to metal surfaces.

### SUMMARY

An embodiment of an anticorrosive metal workpiece includes an anticorrosive metallic coating principally composed of sprayed zinc particles adhered to a metal surface of the workpiece and a protective coating covering the metallic coating.

One embodiment of an anticorrosive metal workpiece is made by the process of selecting the metal workpiece; cleaning and surfacing the workpiece by abrading; heating the cleaned and surfaced workpiece; applying a metallic coating of anticorrosive metal to the heated workpiece; applying a protective coating to the metallic coating; curing the protective coating; and quenching the metal workpiece having the metallic coating and the cured protective coating thereon.

The foregoing has outlined some of the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is a flow chart illustrating an anticorrosive coating process according to an embodiment of the present invention;

FIG. 2 is a flow chart illustrating an anticorrosive process according to a second embodiment of the present invention;

FIG. 3 is a side view of a section of “black bar” rebar as it may be received from a steel manufacturing facility;

FIG. 4 is a side view of a section of rebar, such as shown in FIG. 1, after a wheel ablation process in accordance with an embodiment of the invention;

FIG. 5 is a side view of a section of rebar, as shown in FIGS. 1 and 2, after a spray coating process in accordance with an embodiment of the invention;

FIG. 6 is a side view of a section of rebar, as shown in FIGS. 1, 2 and 3, after a thermal epoxy application process in accordance with an embodiment of the invention.

### DETAILED DESCRIPTION

Refer now to the drawings wherein depicted elements are not necessarily shown to scale and wherein like or similar elements are designated by the same reference numeral through the several views.

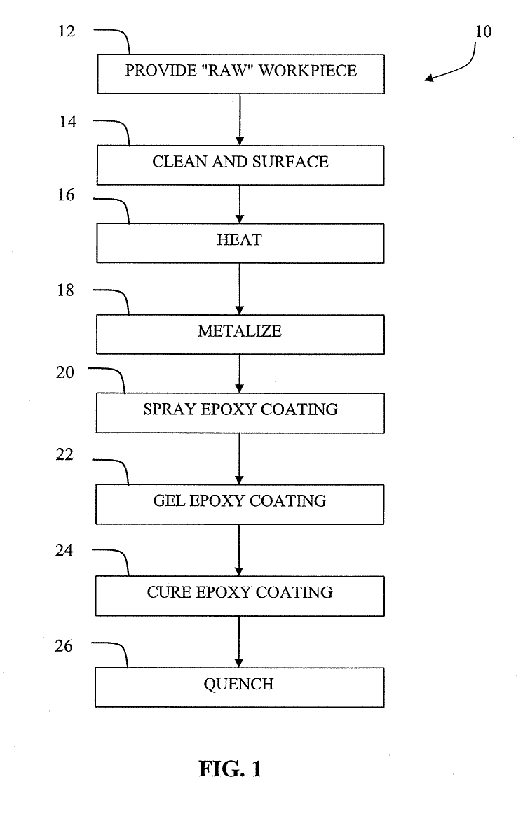

Referring to FIG. 1, a flowchart illustrating a method of applying an anticorrosive coating according to an embodiment of the present invention is shown generally at 10. At 12, a “raw” metal workpiece is provided. Such a metal piece may be an object formed from metal that may be susceptible to corrosion, such as steel. In one embodiment, a section of steel rebar may be loaded on a coating manufacturing line via rollers. While the embodiments of the invention described herein are generally directed to an anticorrosive coating process for steel rebar, the invention may be applied to coat numerous other types of metal objects, such as structural beams, steel bridge components or motor vehicle frames, as some examples.

At 14, the metal object to be coated is cleaned and surfaced. In this regard, preparing steel rebar with a “near white” finish, such as is described in the Painter's Council Handbook or the specifications known as “Visual Reference SP10” or “SS Visual 1” in the Steel Structures Painting Council (SSPC), may be desired. One technique for accomplishing such surface preparation is by wheel ablation. Wheel ablation may be accomplished by employing a wheel that includes plural vanes, or blades. The wheel may be rotated at a high rate of speed and sand, or other abrasive material (“sand”), introduced into the rotating wheel. The sand may then be expelled from the wheel at a high rate of speed and impinge on the metal object. In this regard, the object being treated may be rotated, or otherwise manipulated, and drawn through the, path of the impinging sand to achieve a substantially consistent surface topology. In this regard, a standard anchor profile, which is known, may be achieved when preparing the surface of steel rebar with wheel ablation. Of course, other techniques may be employed, and the invention is not limited to the use of wheel ablation. For example, conventional sandblasting techniques may be employed, as one alternative. Such surface preparation may remove any corrosion on the surface of the metal object and also provide a surface that improves adhesion of subsequent materials applied to the object, as is discussed below.

At 16, the object may be heated. Such heating may be accomplished using a furnace, oven or heat induction coil. Such heating may further improve the adhesion of materials applied in subsequent operations of the process. The temperature to which the bar is heated will depend on the specific embodiment and materials used. Typically, temperatures for embodiments in accordance with the invention may range from 430-550 degree F., though the invention is not limited in this respect. As indicated above, the specific temperature may depend on the particular materials used to coat the metal object, such as metallization alloy and epoxy powder, for example.

At 18 in FIG. 1, a metal object being coated may be metalized, or coated with an anticorrosive metal. Various techniques for performing such coating are possible. For example, an arc spray system may be employed and is well known. Such a system that may be used is the Model BP400 Arc Spray System, available from Praxair Surface Technologies, Inc., Thermal Spray Products, N670 Communication Drive, Appleton, Wis. 54915. According to a datasheet for such spray system (Revision A Apr. 1, 1998) included as Exhibit A in applicant's parent U.S. patent application Ser. No. 10/326,610, filed Dec. 20, 2002, which is hereby incorporated herein by reference, such arc spray system is used in handheld and robotic applications in industries including tubing and extrusion, general machine and maintenance, automotive, cookware, aerospace, pulp and paper, and medical industries, among others. For example, such a spray system has previously been used to coat oil-well pump sucker rods with a stainless steel coating, which is then covered by an epoxy coating.

Employing such a spray system, an anticorrosive metal may be sprayed over the surface of the metal object being coated. Typically, a gun of such a spray system would, during operation, be slid back and forth in a parallel path to the metal object being coated. This motion of the gun may improve uniformity of the coating, which is desired, but such motion is not essential. In such a system, wire is typically employed as the metal source. Compositions for such wires may vary. For example, wire composed of an alloy of ninety-eight percent zinc and two percent aluminum by weight has been discovered to be preferable for the present invention, but compositions principally of zinc, for example from one hundred percent zinc to about eighty-five percent zinc by weight with a balance principally of aluminum, may be used. Compositions principally of zinc are preferred for this application because, in the event of damage to an outer polymeric protective coating which covers the zinc coating as described hereafter, zinc corrosion products such as zinc oxide occupy much less volume than iron oxides and can also diffuse into surrounding concrete, thereby reducing tensile stresses between the concrete and the coated metal object, such as steel rebar, to prevent cracked concrete. In other embodiments, a pseudo-alloy spray may be applied. In such applications, a pure zinc wire and a pure aluminum wire may be employed, with the amount of each wire consumed during application to an object controlled to achieve a desired alloy ratio.

An electrical arc typically vaporizes wire in such a system. This vapor is then sprayed on the surface of the metal object being coated. Preferably, the resulting coating thickness is in a range from about 1.5 mils to about 2.0 mils. This ensures against too thin a coating, which would have poor corrosion resistance, and too thick a coating, which would have a tendency to crack if bent in a manner commonly required with steel rebar. The invention is not limited to the particular alloys or techniques discussed above, and other equipment, material, or approaches may be employed, such as the use of plasma or cold spray systems.

At 20, in FIG. 1, an epoxy powder may be sprayed onto the heated, metalized object being coated in a chamber. Epoxy powders suitable for such an application are available and are well known. For example NAP-GARD 7-2719 is available from DuPont Powder Coatings, 9800 Genard, Houston, Tex. 77041. According to a datasheet for this powder previously included as Exhibit B in applicant's parent U.S. patent application Ser. No. 10/326,610, filed Dec. 20, 2002, which is hereby incorporated herein by reference, NAP-GARD 7-2719 is a thermosetting epoxy powder designed to coat reinforcing steel rebar to provide corrosion protection, and is designed specifically for application to straight bars that are subsequently bent. It has been certified to meet the specifications-known as 775-97 and AASHTO M284. It is a green powder having a specific gravity of 1.27 plus or minus 0.05, a coverage of 152 square feet per pound per mil, a shelf life of six months, a gel time of 8-10 seconds in accordance with ASTMD-3451-92 at 205 degrees C., a flexibility in accordance with D. P. C. 10.227 which passes a 4d bend on number 4 bar at 23 degree C. at 7-11 mils, a Knoop hardness number in accordance with AASHTO M284 A. 1.4.8 of 15.0 average at 10 mils thickness, and a chemical resistance in accordance with ASTM G 20 of forty-five days at 24 degree C. in 3 molar NaCl and 7% NaCl. Such a powder is typically applied dry, and melts upon contact with the heated metal object, such as steel rebar. Epoxy powder may be sourced for such application from a vat, where pumping dry air through the powder may fluidize it to facilitate spraying. Additionally, an electrostatic charge may be introduced into the epoxy powder to improve attraction of the powder with an object being coated, such as grounded steel rebar.

At 22, the melted epoxy may gel. Because rollers may be employed for such coating processes, such as for coating steel rebar, a gel time is typically employed to allow a thermal-setting epoxy to harden, in order to prevent damage from the first roller encountered after the epoxy is applied. Gel times may vary depending on the particular epoxy employed, and on the ambient environment conditions. In this regard, gel times may be in the range of three to twelve seconds, though the invention is not so limited and longer or shorter gel times may be possible. However, shorter-gel times are typically desirable to allow for increased manufacturing line speed.

At 24, the epoxy coating is cured. For steel rebar coating processes, wet canted rollers may be used to prevent damage to the coating and to rotate the rebar for facilitating earlier coating operations on the object being coated. Cure time is the time employed to complete the thermosetting of the epoxy coating. While the cure time depends on the particular embodiment, cure times typically range from twenty to thirty-five seconds.

At 26, the object, such as rebar, may be quenched. Quenching may be accomplished by passing the coated rebar through a series of low-pressure water streams. Quenching reduces the temperature of the rebar and further hardens the epoxy coating to prevent damage from handling after the completion of the coating process. It is noted that quenching and curing are distinct operations and applying a water stream prior to the completion of the epoxy cure may result in damage to the coating.

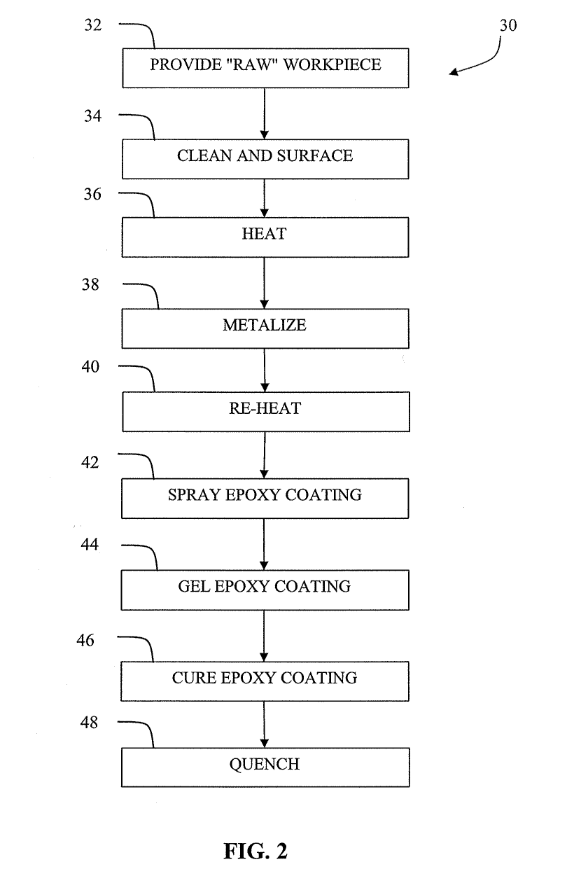

An alternative method for applying an anticorrosive coating is shown in FIG. 2 and indicated generally at 30. Method 30 is similar to method 10 and, therefore, only the differences in the two processes will be discussed below. For method 30, heating of the object being coated is done in two operations, 36 and 38, rather than one operation as was the case with method 10. In this respect, an object to be coated may be preheated at 36. The temperature of preheat at 36 would typically be a lower temperature than indicated above for heating at 16. For example, an object may be preheated to approximately 300 degrees F. at 36. This lower temperature may be employed to improve adhesion of the metallization applied at 38 for certain alloy compositions. An object being coated may then be reheated to a temperature appropriate for applying epoxy coating at 42. These temperatures may be in the range of those discussed above with respect to method 10. As a further alternative, the preheating operation 36 could be eliminated.

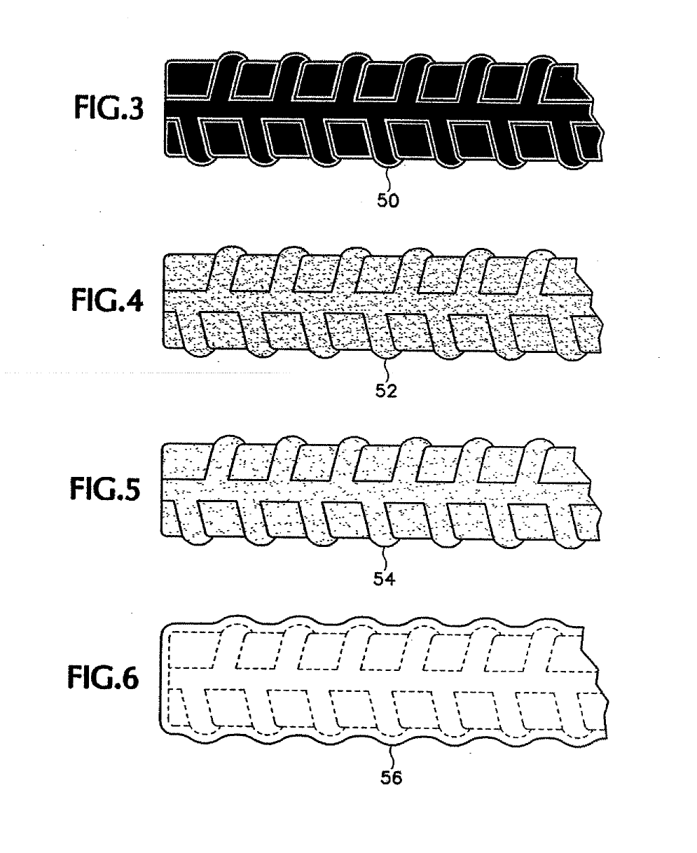

FIGS. 3-6 show sections of rebar at various points in a coating process such as those just discussed. In this regard, FIG. 3 shows a section of “raw” or “black” rebar 50. Rebar 50 appears as it may be received from a steel manufacturer, prior to any processing. FIG. 4 shows a section of rebar 52 after cleaning and surface preparation, such as may be done with wheel ablation. FIG. 5 shows a section of rebar 54 after metallization with a zinc-aluminum alloy using an arc spray system, as previously discussed. FIG. 6 shows a section of rebar 56 after epoxy powder application, gel, cure and quench. Rebar 56 appears as it may be shipped to a customer for use in various structural or construction applications.

From the foregoing detailed description of specific embodiments of the invention, it should be apparent that a method and apparatus for anti-corrosive coating that is novel has been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

What is claimed is:

1. An anticorrosive metal workpiece, the workpiece comprising:
an anticorrosive metallic coating principally composed of sprayed zinc particles adhered to a metal surface of the workpiece; and
a protective coating covering the metallic coating.

2. The workpiece of claim 1, wherein the metallic coating has a thickness within a range of about 1.5 mils to about 2.0 mils.

3. The workpiece of claim 1, wherein the metallic coating is within a range of about 85% to about 100% zinc by weight, with a balance principally of aluminum.

4. The workpiece of claim 1, wherein the metallic coating comprises about 98% zinc and about 2% aluminum by weight.

5. The workpiece of claim 1, wherein the protective coating is principally epoxy.

6. The workpiece of claim 1, wherein the workpiece is steel rebar.

7. An anticorrosive metal workpiece made by the process of:
selecting the metal workpiece;
cleaning and surfacing the workpiece by abrading;
heating the cleaned and surfaced workpiece;
applying a metallic coating of anticorrosive metal to the heated workpiece;
applying a protective coating to the metallic coating;
curing the protective coating; and
quenching the metal workpiece having the metallic coating and the cured protective coating thereon.

8. The anticorrosive metal workpiece of claim 7, wherein the metallic coating is applied by spraying.

9. The anticorrosive metal workpiece of claim 7, wherein the heating raises the cleaned and surfaced workpiece to a temperature of about 430° to about 550° F.

10. The anticorrosive metal workpiece of claim 7, further comprising the step of additionally heating the metal workpiece after the application of the metallic coating.

11. The anticorrosive metal workpiece of claim 10, wherein the heating of step c raises the cleaned and surfaced workpiece to a temperature of about 300° F.

12. The anticorrosive metal workpiece of claim 11, wherein the step of additional heating raises the temperature of the workpiece having the metallic coating thereon to a temperature of about 430° to about 550° F.
